(19) United States
(12) Patent Application Publication
(10) Pub. No.: US 2008/0096621 A1
(43) Pub. Date: Apr. 24, 2008

(54) Method For Removing Straw From Agricultural Products And A Straw Removing Device For Carrying Out Said Method

(75) Inventor: Maurice Perret, Gruffy (FR)

Correspondence Address: YOUNG & THOMPSON, 745 SOUTH 23RD STREET, 2ND FLOOR, ARLINGTON, VA, 22202, US

(73) Assignee: ODDEIS, Paris (FR)

(21) Appl. No.: 11/792,618

(22) PCT Filed: Dec. 8, 2005
(86) PCT No.: PCT/EP05/56611

§ 371 Date: Jun. 8, 2007

(30) Foreign Application Priority Data
Dec. 16, 2004 (FR) 0413426

(51) Int. Cl. A01F 12/30; A01F 12/40

(52) U.S. Cl. 460/119; 460/134

(57) ABSTRACT

The present invention relates to a straw removal method designed in particular to remove the leaves and other plant debris along agricultural products such as corn stalks or sugar canes. The invention also relates to a straw removal device for applying the method of the invention. The device comprises at least one transfer belt (9) carrying the agricultural products to be treated, a device (1-3) for blowing air through the transfer belt, and finally, an aeraulic bell (11-13) designed to orient (10) the air flow and/or the plant debris transported in the air flow and to tear off the unnecessary plant debris (A2) such as the leaves of the agricultural product and to transfer them to a receptacle zone (14).

The present invention relates to a straw removal method designed in particular to remove the leaves and other plant debris along agricultural products such as corn stalks or sugar canes.

The invention also relates to a straw removal device for applying the method of the invention.

In the prior art, agricultural products such as corn or sugar canes are harvested with the aid of harvesters and are loaded into receptacles in order subsequently to be transferred to a factory for conditioning, treating, or preparing food products for human food or animal feed.

During harvesting, a certain amount of plant debris, stones and foreign bodies are collected at the same time as the useful portions of the harvested plants.

The present invention makes it possible to treat the masses of harvested plant products so as to separate therefrom the unnecessary plant debris and, incidentally, the stones. In addition, the present invention makes it possible to make use of the mass of such waste by allowing it to be recovered and, where necessary, by providing a treatment allowing its reinjection into an economic circuit. This is the case with the reuse of straw and leaves removed from sugar canes for feeding fiber to livestock. Specifically, sugar cane is a crop that uses large agricultural areas and, in the agricultural economy of a region, the area that may then be allocated to pasture and/or to the production of forage plants is then reduced. This leads to the need to import into the region particularly meat and dairy products. The reuse of straw, leaves and other plant debris originating from sugar cane, after the harvest and at the beginning of the process for manufacturing cane sugar therefore makes it possible to envisage feeding a larger herd. In another application, the recovered plant mass may be used as an indirect source of electric energy either by burning or by oxidation in biomass form. In the case of burning, the recovered plant mass may be treated so as to remove a portion of the humidity contained and thereby increase the mass calorific power.

In the prior art, it has already been proposed to use air flows produced by cyclones in aeraulic and/or mechanical treatment apparatus in order to separate the leaves, straw and other plant debris from the plant mass at the entrance of a factory for treating freshly harvested agricultural products.

However, it has been found that the plant debris that is likely to be removed from the plant mass is only the plant elements that are already detached and there still remains a majority of plant portions attached to the stalks.

Furthermore, the plant debris that is then carried by the cyclone is usually clustered together in the plant mass and produces blockages in the elements allowing the transfer of the treated plant mass.

The result of this is that the agricultural product treatment flow must then be stopped in order subsequently to carry out an unblocking operation.

The result of this is loss of products and a waste of time.

The present invention provides an enhancement to this prior art in that:
the general efficiency of the agricultural production process such as that of cane sugar based on sugar cane is increased by reducing the volume of waste more than it is reduced in the prior art;
by reducing the downtime of the installation caused by the blockages that are completely eliminated in the entrance section.

Specifically, the present invention relates to a method for removing straw from agricultural products such as corn or sugar canes, which consists, in a first step, in placing and orienting the agricultural products in a preferred direction, then, in a second step, in separating and standing the plant debris and straw perpendicular to at least one layer of oriented agricultural products, in a third step, in carrying out a treatment of the plant debris that adheres to the agricultural products and finally, in a fourth step, in separately expelling the plant debris and the treated agricultural products.

The invention also relates to a device for removing trash or straw from agricultural products. It comprises at least one transfer belt carrying the agricultural products to be treated, a device for blowing air through the transfer belt, and finally, an aeraulic bell designed to channel the air flow and/or the plant debris torn off and transported in the air flow such as the leaves of the agricultural product and to transfer them to a receptacle zone.

Other features and advantages of the present invention will be better understood on reading the following detailed description and the figures that are:

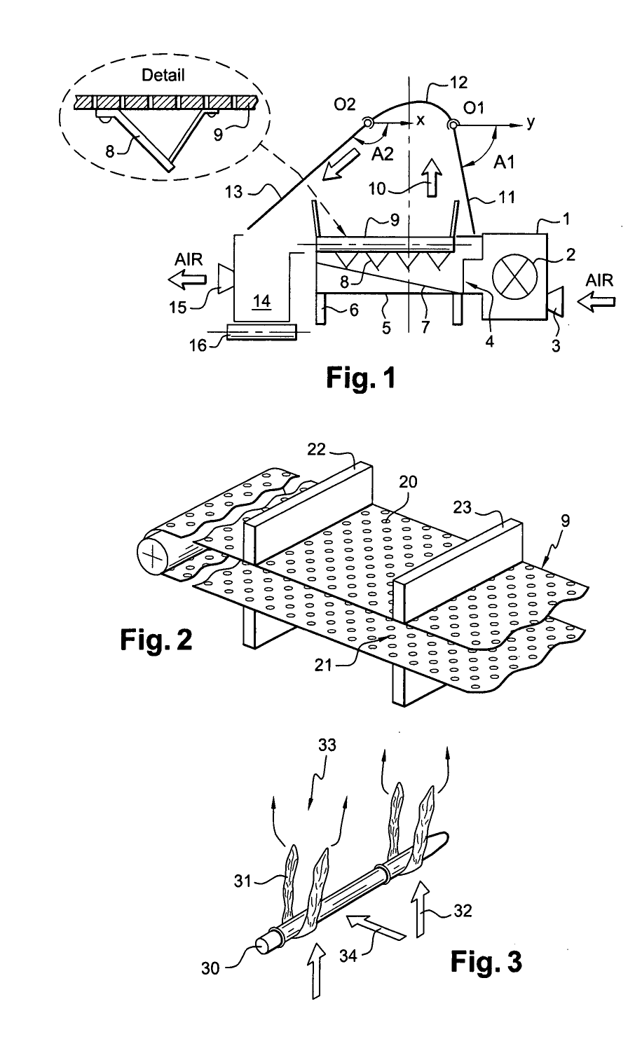

FIG. 1 is a schematic diagram of a straw removal device according to the invention;

FIG. 2 is a schematic diagram of a belt used in the straw removal device of FIG. 1;

FIG. 3 is a drawing representing schematically a sugar cane still carrying plant debris that is oriented and floating in the air flow produced by the device of FIG. 1 or 2;

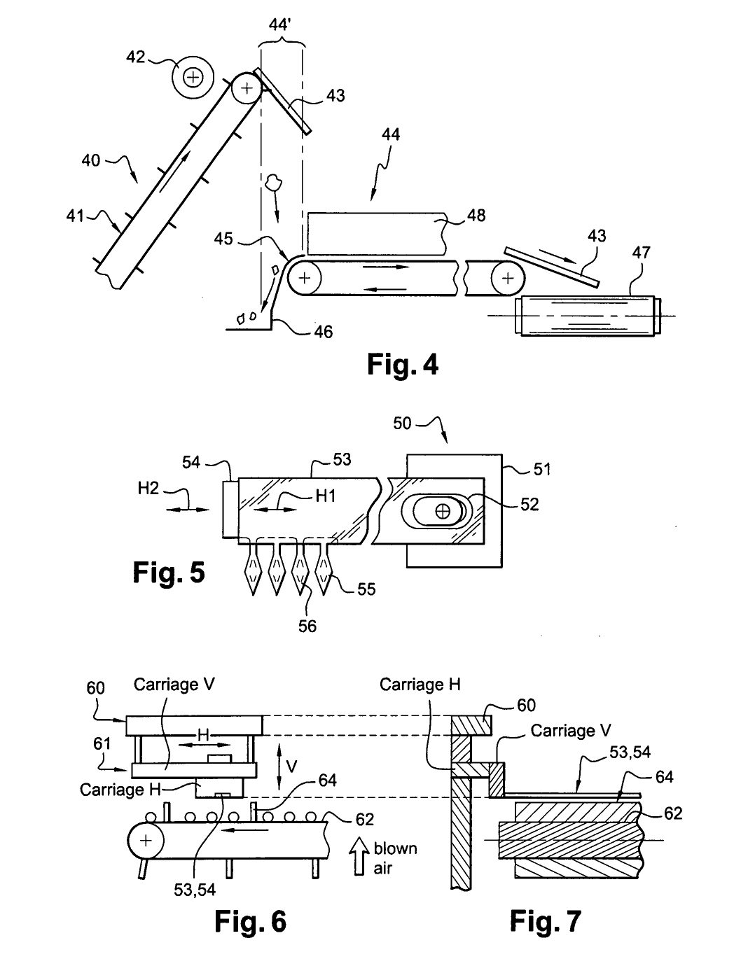

FIG. 4 represents a schematic diagram of an installation applying the method of the invention;

FIG. 5 represents a mechanism designed to weaken the leaves and other plant debris on the agricultural product;

FIG. 6 represents the installation of such a weakening device on a portion of the device represented in FIG. 1 or 2;

FIG. 7 is another view of the device of FIG. 6;

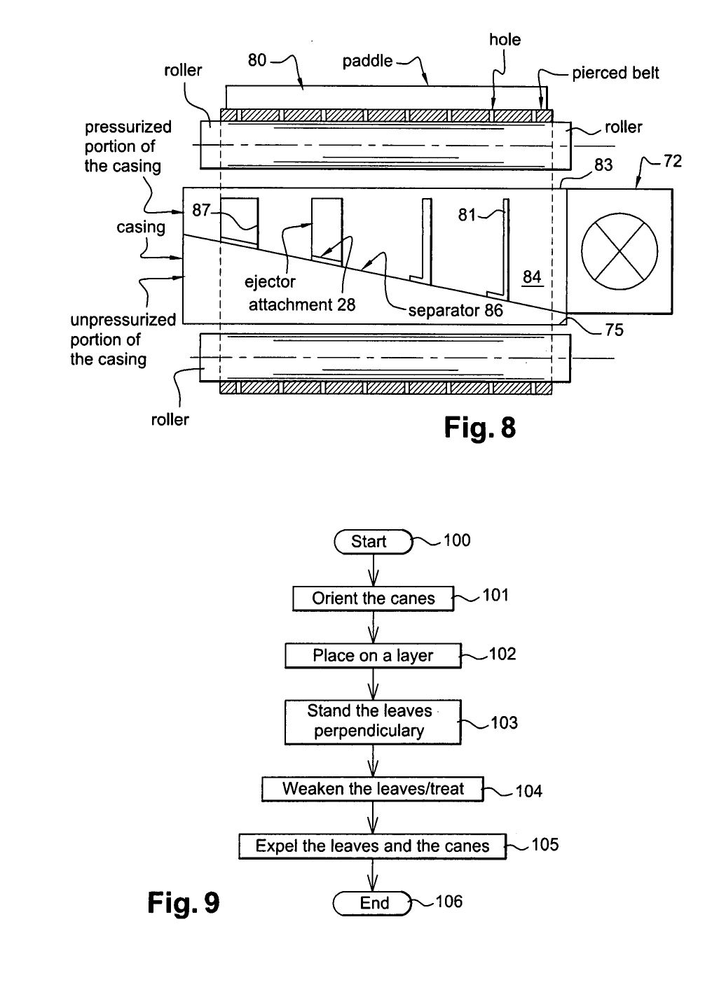

FIG. 8 represents a diagram in section of a portion of the device of FIG. 1 or 2;

FIG. 9 represents a flowchart of the method of the invention; and

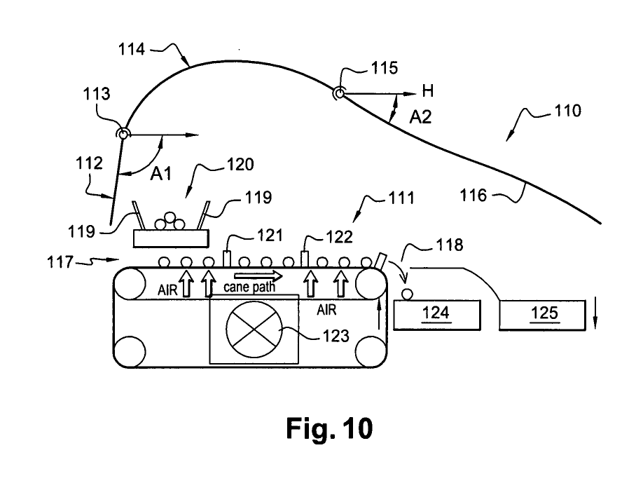

FIG. 10 represents another embodiment of an installation according to the invention.

FIG. 1 shows one embodiment of a straw removal device according to the invention.

The device of FIG. 1 is shown as seen from the entrance of the agricultural products onto the belt 9. The speed of the belt and its length are important parameters that are determined according to the information that follows.

The belt 9 travels on a casing 5 that is connected to the outlet nozzle 4 of a fan 1 that is furnished with blades and that collects air through an inlet nozzle 3 open to the outside air.

Pressurized, the casing 5 that is limited by a triangular section on each side and a bottom wall 7 whose inclination makes it possible to regulate the pressure of air blown by the fan 1 in the direction of the width of the belt 9.

The belt 9 limits the top face of the casing 5 and is pierced by openings allowing the flow of air blown into the casing 5 to pass through it.

The blown air then travels in the vertical direction 10 and is captured by a bell 12 consisting of a first substantially flat panel 11 that can be oriented about an axis O1, then of a rounded portion 12 closing the bell itself and terminated by a substantially flat panel 13, itself able to be oriented if necessary, and that directs, in the direction of the arrow 10′, the outgoing air flow and the captured debris to a receptacle casing 14 for the captured plant debris.

In one embodiment, the aeraulic bell 9-11 comprises at least one orientable panel so as to promote the separation of the plant debris from the agricultural products.

The receptacle casing 14 may be terminated by a blown air expulsion nozzle 15 that interacts with a filter (not shown) and that makes it possible to retain the plant debris. The receptacle casing may also interact with a belt 16 for expelling leaves and other plant debris.

In a particular embodiment, the air blowing device 1-4 interacts with a casing 5-8 furnished with means for balancing the aeraulic flow through the belt 9 comprising an inclined partition 7 and/or a plurality of orientable deflectors 8.

The casing 5 situated beneath the active portion of the belt 9 consists of a partition 7, that runs along the belt, and is inclined relative to the cross section of the casing 5 and that makes it possible to maintain a speed of air circulation and a constant pressure in the casing 5 in which the pressurized air blown by the fan is transferred through the holes of the belt 9 into the bell 12.

To adjust the air streams, the wall 7 that separates the two portions of the casing 5 is fitted with deflectors, such as the deflector 8, substantially parallel with the belt 9 on the one hand, and whose inclination in the transverse direction of the belt 9 is determined so as to optimize the expulsion of the plant debris by the air flow in the bell 12.

Each deflector 8 comprises a wall inclined relative to the bottom of the horizontal table 9 to which the deflector 8 is attached in a known manner, for example by lugs screwed into the drill holes of the table 9. The deflector wall is inclined at an angle determined in at least one perpendicular plane or horizontal plane of the bottom of the table 9 and this or these inclination(s) is (are) adjusted by the length of the arms that hold the end of the wall of the deflector 8, opposite to the end supporting the lugs for attaching the deflector 8, on the bottom of the table 9. In one embodiment, the inclined bottom 7 of the air blowing casing, placed beneath the bottom of the table 9, is inclined at 30° below the horizontal plane and the deflectors are adjusted with angles from 20° to 10° under the horizontal plane.

The orientation of the partition 7, the number, disposition and orientation of the deflectors 8 are determined in manufacture, during installation, or during maintenance, or else under the control of a programmable controller.

The bell 12 consisting of the represented panels 11 to 13 is also closed in the plane of the figure at the two ends of the belt by flat panels not shown.

These panels are removable only during maintenance of the machine.

The height of the belt 9 may be adjusted by modifying the length of the feet, such as the foot 6 that separates the casing 5 from the ground on which it is placed.

FIG. 2 shows a portion of the belt 9 that is fitted in its active portion with holes such as the hole 20 allowing the passage of air blown by the blowing casing 5 (FIG. 1) and that is placed in the space 21 represented in FIG. 2.

The belt 9 furthermore comprises a plurality of paddles and scrapers such as the paddles 22 and 23, placed across the belt and between which a single layer of agricultural products such as sugar canes is placed.

In one embodiment, each plant or agricultural product to be treated is placed along its largest dimension parallel to the paddles, that is to say transverse to the belt.

The height of the paddles is calculated so as to retain a layer of a predetermined thickness, for example of a single plant, so that the air flow can easily treat all the leaves of the plant placed on the belt.

FIG. 3 shows a sugar cane 30 that consists of a substantially cylindrical section along which at regular intervals there is plant debris that forms shapes of elongate leaves such as the leaf 31.

When the flow of blown air 32 is directed from below at the sugar cane, the leaves such as the leaf 31 are directed perpendicularly to the general direction of the cane in the air flow and are progressively torn off by the air flow 32 to take the directions like the arrows 33 in the bell of the device of the invention.

The direction of travel of the canes on the belt is represented by the arrow 34.

In a particular embodiment, the trash removal device is preceded by an agricultural product orientation and feeding means so as to obtain an orientation and a controlled thickness of agricultural products to be treated. Particularly, the orientation and feeding means comprises a rapid traveling belt and, where appropriate, retention plates bordering the rapid belt.

FIG. 4 shows a treatment installation incorporating the invention.

On the left of the drawing, a loader 40 is shown consisting substantially of an inclined paddle chain 41 on which are placed plant masses originating from trucks and other containers that have brought the agricultural product.

Placed at the top of the paddle chain 41 is an auger 42 placed across the belt and in the top portion of the latter to untangle and smooth the wads of plants that rise along the paddle chain 41.

At the apogee of the paddle chain 41, the plants such as a sugar cane 43 are tipped into the void, from a predetermined height and tend to fall on the rapid belt 44 that serves as a means of orienting the plants such as the canes so as to place them parallel to a given direction.

In the plant mass that falls into the space 44 made between the top of the loader 40 and the beginning of the orientation belt 44, the stones or other heavy, nonplant debris are then sorted with the aid of a trough 45 that transfers them to a stone expulsion means 46.

The orientation belt 44 has a width and speed of travel that are calculated so as to ensure a correct orientation of the sugar canes and to load them onto the trash remover 47 placed perpendicularly to the axis of travel of the rapid belt 44.

The sugar canes, substantially oriented across the direction of travel of the belt 47, fall onto its entrance section and are then treated as has been indicated with the aid of FIGS. 1 and 2.

In a preferred embodiment, the rapid belt 44 for orienting the canes is bordered laterally by two retention plates such as the plate 48.

These plates make it possible to enhance the alignment effect by trapping the canes and forcing them, by rubbing the sugar canes on the plate, to reorient themselves parallel to the direction of travel.

Other orientation means are also available that those skilled in the art may adapt according to the circumstances.

FIG. 5 shows a schematic diagram of a means for weakening the leaves and other plant debris that remain adhering to the actual body of the agricultural plant during treatment such as a sugar cane or a corn stalk.

Particularly, the straw removal device of the invention also comprises a tool that cuts the plant debris and that is placed on the final section of the belt 9.

The means for weakening the plant debris consists, in one embodiment, of a double saw 50 that mainly consists of a support 51 on which is mounted a reciprocating mechanism 52 that mobilizes two saws, respectively the saw 1, reference number 53, and the saw 2, reference number 54.

Each saw is driven in a reciprocating movement so that the teeth, such as the teeth 55 on the saw 53 and the teeth 56 on the saw 54 tend to shear all the plant debris such as the leaves that are presented to the teeth when the sugar cane, transported by the belt 9 (FIG. 2) and subjected to the air flow that stands the leaves perpendicular to the belt 9 (see 31, FIG. 3), comes level with the double saw.

FIG. 6 shows the exit section of a trash remover as shown in particular in FIGS. 1 and 2.

In the exit section of the trash remover, the leaves or other plant debris that have not yet been expelled by the air flow float and are placed “flag-like” perpendicular to the belt.

The weakening mechanism is then supported by a main carriage 60 fixedly attached to the stand of the machine and on which a secondary carriage 61 can be moved that supports the actual weakening mechanism 62.

The weakening mechanism in this instance consists of a double saw such as the saw 50 of FIG. 5, and the teeth of the double saw are presented toward the entrance of the trash remover.

The belt 62 supports paddles like the paddle 64 and the carriages 60 and 61 make it possible to place longitudinally and vertically in the directions V and H indicated in FIG. 6, relative on the one hand to the belt 62 on which the sugar canes are placed, and, on the other hand, the height of the paddles like the paddle 64.

During the pass, the double saw 62 is actuated as the belt goes by and takes off the last leaves remaining adhering that are then caught up by the air flow in the terminal section of the trash remover of the invention.

FIG. 7 shows a detail of the casing placed in the internal space of the transfer belt.

The transfer belt 70 is pierced with holes as has been described.

In another embodiment, the transfer belt 70 consists of a mesh or a series of screens separated by gaps or by any other flat element having air passage openings and holding the agricultural products during their trash removal.

Placed on the bottom face of the active portion 70 of the belt there is, as has been described, a casing whose top portion is open and in fluid communication with the holes of the belt 70.

The belt also supports, on its top face, paddles such as the paddle 71.

The fan 72 is in fluid communication via an inlet nozzle 73 with the pressurized portion 74 of the casing 75.

The separation plate 76 then supports a plurality of injectors such as the N injectors 77_1 to 77_N that have orientations that can be adjusted at least during the configuration of the machine, and, where necessary, under the effect of an orientation mechanism that can be controlled from the outside and not shown in FIG. 8. The injectors 77_1 to 77_N are firmly attached to the separator 86 with the aid of a folded portion, adapted to the plate of the separator 86 and furnished with a fastening means 88.

To operate, the device of the invention interacts with a controller that makes it possible to determine in particular the rate of entry of the agricultural plants to be treated, the speed of travel of the belt of the straw removal device itself, and the operating parameters of the device for weakening the plants.

The straw removal method of the invention relates to agricultural products such as corn or sugar canes. It consists, in a first step, in placing and orienting the agricultural products in a preferred direction, then, in a second step, in standing the plant debris and straw perpendicular to at least one layer of oriented agricultural products, in a third step, in carrying out a treatment of the plant debris that adheres to the agricultural products and finally, in a fourth step, in separately expelling the plant debris and the treated agricultural products.

In one embodiment, the third treatment step comprises a step for weakening the plant debris that still adheres to the agricultural products.

In one embodiment, the step for weakening the plant debris comprises a step for cutting or tearing off the plant debris.

FIG. 9 shows the flowchart of a particular embodiment of the method of the invention.

After a start phase 100, the method of the invention involves determining, during a step 101, the orientation of the canes in a preferred direction.

During a second step 102, the method of the invention consists in placing the agricultural products such as sugar canes on a layer of a predetermined thickness such as a thickness limited to a single plant.

During a third step 103, the leaves and other plant debris mixed in the layer of agricultural products are separated from the stalks.

In a step 104, the method of the invention then consists in weakening the leaves and/or carrying out a treatment of the latter which makes it possible in particular to remove the insects and bacteria, where necessary, and the fungi thanks to the use of a predetermined treatment.

And finally, during a step 105, the leaves and other plant debris, on the one hand, and the stripped agricultural products, on the other hand, are selectively expelled.

During a step 106, control is relaxed.

FIG. 10 shows another embodiment of a straw removal device. In such an embodiment, the straw removal device interacts with at least one recycled air thermodynamic treatment machine, placed in relation with the mass of torn-off plant debris and/or with the mass of agricultural products with the trash removed, so that a drying/dampening, energy recovery, and/or cooling/heating treatment can be carried out on one and/or the other of the two separated masses.

In the device of this embodiment, the aeraulic bell 110 is directed perpendicular to the direction of the aeraulic bell 12 of FIG. 2.

Accordingly, the housing 111 is placed close to the plane 112 closest to the bell.

It can be adjusted in inclination at an angle A1 to the horizontal about an articulation 113 connected to a curved portion 114 in the second adjustable plane 116 is articulated on the curved portion with the aid of an articulation 115 so as to adjust the inclination A2 relative to the horizontal.

The extension of the panel 116 makes it possible to pass beyond the exit of the straw removal belt 111 that comprises an entrance section 117 and an exit section 118.

The section 117 is coupled with the exit section 119 of the device for orienting the canes or other agricultural products that has already been described in the form of a belt fitted with two lateral retention plates 120 and 121.

At the end of this orientation belt 120, the canes are tipped and distributed onto a layer between the paddles 121, 122 of the straw removal belt 111.

The straw removal belt 111 is, as has already been described, associated with a blowing casing that will not be further described, but that is connected to a blowing fan 123.

The exit section 118 of the straw removal belt 111 discharges onto a section for transferring the agricultural products such as sugar canes with the straw removed 124 and onto a section 125 for expelling the debris and other torn-off leaves, as has already been described, with the aid of the straw removal belt 111.

At the exit 118 of the straw removal belt 11, the treated canes fall onto the belt 124 and are then expelled for example in a movement perpendicular to the plane of the figure.

The separated leaves are ejected toward the top of the aeraulic bell 110 and redescend along the inclined wall 107 because of counter pressure applied by the fan 123 through the belt 111.

The leaves necessarily redescend onto the expulsion device 125 that may consist of a box or another expulsion belt.

1. A method for removing straw from agricultural products such as corn or sugar canes, characterized in that it consists, in a first step, in placing and orienting the agricultural products in a preferred direction, then, in a second step, in separating and standing the plant debris and straw perpendicular to at least one layer of oriented agricultural products, in a third step, in carrying out a treatment of the plant debris that adheres to the agricultural products and finally, in a fourth step, in separately expelling the plant debris and the treated agricultural products.

2. The method as claimed in claim 1, characterized in that the third treatment step comprises a step for weakening the plant debris that still adheres to the agricultural products.

3. The method as claimed in claim 1, characterized in that the step for weakening the plant debris comprises a step for cutting up the plant debris.

4. A device for removing straw from agricultural products, characterized in that it comprises at least one transfer belt (9) carrying the agricultural products to be treated, a device (1-3) for blowing air through the transfer belt, and finally, an aeraulic bell (11-13) designed to channel (10) the air flow and/or the plant debris torn off and transported (A2) in the air flow such as the leaves of the agricultural product and to transfer them to a receptacle zone (14).

5. The device as claimed in claim 4, characterized in that the air blowing device (1-4) interacts with a casing (5-8) furnished with means for balancing the aeraulic flow through the belt (9) comprising an inclined partition (7) and/or a plurality of orientable deflectors (8).

6. The device as claimed in claim 4, characterized in that it is preceded by an agricultural product orientation and feeding means so as to obtain an orientation and a controlled thickness of agricultural products to be treated.

7. The device as claimed in claim 4, characterized in that the orientation and feeding means comprises a rapid traveling belt and, where appropriate, retention plates bordering the rapid belt.

8. The device as claimed in claim 7, characterized in that the aeraulic bell (9-11) comprises at least one orientable panel so as to promote the separation of the plant debris from the agricultural products.

9. The device as claimed in claim 4, characterized in that it also comprises a tool for cutting up the plant debris placed on the final section of the belt (9).

10. The device as claimed in claim 4, characterized in that it interacts with at least one recycled air thermodynamic treatment machine placed in relation with the mass of torn-off plant debris and/or with the mass of agricultural products with the trash removed, so that a drying/dampening, energy recovery, and/or cooling/heating treatment can be carried out on one and/or the other of the two separated masses.

11. The method as claimed in claim 2, characterized in that the step for weakening the plant debris comprises a step for cutting up the plant debris.

12. The device as claimed in claim 5, characterized in that it interacts with at least one recycled air thermodynamic treatment machine placed in relation with the mass of torn-off plant debris and/or with the mass of agricultural products with the trash removed, so that a drying/dampening, energy recovery, and/or cooling/heating treatment can be carried out on one and/or the other of the two separated masses.

13. The device as claimed in claim 6, characterized in that it interacts with at least one recycled air thermodynamic treatment machine placed in relation with the mass of torn-off plant debris and/or with the mass of agricultural products with the trash removed, so that a drying/dampening, energy recovery, and/or cooling/heating treatment can be carried out on one and/or the other of the two separated masses.

14. The device as claimed in claim 7, characterized in that it interacts with at least one recycled air thermodynamic treatment machine placed in relation with the mass of torn-off plant debris and/or with the mass of agricultural products with the trash removed, so that a drying/dampening, energy recovery, and/or cooling/heating treatment can be carried out on one and/or the other of the two separated masses.

15. The device as claimed in claim 8, characterized in that it interacts with at least one recycled air thermodynamic treatment machine placed in relation with the mass of torn-off plant debris and/or with the mass of agricultural products with the trash removed, so that a drying/dampening, energy recovery, and/or cooling/heating treatment can be carried out on one and/or the other of the two separated masses.

16. The device as claimed in claim 9, characterized in that it interacts with at least one recycled air thermodynamic treatment machine placed in relation with the mass of torn-off plant debris and/or with the mass of agricultural products with the trash removed, so that a drying/dampening, energy recovery, and/or cooling/heating treatment can be carried out on one and/or the other of the two separated masses.
